(19) United States
(12) Patent Application Publication
(10) Pub. No.: US 2003/0197110 A1
(43) Pub. Date: Oct. 23, 2003

(54) Sliding articulated extension-retraction mechanism

(76) Inventor: Kan Cui, Sammamish, WA (US)

Correspondence Address: Richard C. Litman, LITMAN LAW OFFICES, LTD., P. O. Box 15035, Arlington, VA, 22215, US

(21) Appl. No.: 10/370,655

(22) Filed: Feb. 24, 2003

Related U.S. Application Data
(60) Provisional application No. 60/363,288, filed on Mar. 12, 2002.

(51) Int. Cl. F16M 13/00

(52) U.S. Cl. 248/585

(57) ABSTRACT

The sliding, articulated, extension-retraction mechanism combines a four-bar parallelogram linkage with a crank-slider.

The crank-slider may be disposed on the interior of the parallelogram, or the crank-slider may be disposed on an extension of the leveling link opposite the fixed or base link, or a second parallelogram linkage may replace the crank-slider.

The parallelogram linkages may be stacked to create an extensible, retractable structure. The joints between stacked parallelograms may be formed by either a rectangular housing with the links of each parallelogram joined to opposite diagonal corners of the housing for a low height-wide base storage position, or a trapezoidal housing with the links of each parallelogram joined to adjacent corners of the housing for a high height-narrow base storage position.

### CROSS-REFERENCE TO RELATED APPLICATION

This application claims the benefit of U.S. Provisional Patent Application Serial No. 60/363,288, filed Mar. 12, 2002.

### BACKGROUND OF THE INVENTION

1. Field of the Invention

The present invention relates to a sliding, articulated, extension-retraction (SAER) mechanism which combines a four-bar parallelogram linkage with a crank-slider. The SAER mechanism can be employed in extensible and retractable structures, such as scaffolds, racks, camping tents, portable masts, folding posts, lifting structures, extendible arms, robotics, walls, and various other applications.

2. Description of Related Art

Traditionally mechanical engineers are taught to analyze linkage mechanisms using a four-bar linkage, which is formed by four bars of unequal length pivotally connected at their ends by pins. The four-bar linkage may be open, or it may be closed. The mechanism is usually analyzed by holding one of the links in a fixed position while moving the remaining links. In a closed four-bar linkage, when both of the links attached to the fixed link are able to rotate 360° around the pivot pin, both links are referred to as cranks. When one of these links is restricted to less than 360° rotation, it is referred to as a rocker or oscillating link. The link opposite to (not directly connected to) the fixed link is referred to as the coupler or connecting link.

When two non-adjacent links are equal in length and are parallel to each other, the linkage becomes a four-bar parallel, or parallelogram, linkage 18, as shown in diagrammatic form in FIG. 15. In FIG. 15, link 20 is a fixed link (indicated by the hash marks under pins 22 and 24) or base link, links 26 and 28 are cranks, and link 30 is the connecting link. Pin 32 pivotally connects crank 26 and connecting rod 30, and pin 34 pivotally connects crank 28 and connecting rod 30. Pins 32 and 34 are not constrained to a fixed position, and are free to rotate with links 26, 28 and 30. Parallelogram linkages are frequently used in parallel rulers, pantographs, and other drawing tools.

When the pivot pin at one of the joints is replaced by a slider constrained to linear or translational movement on or parallel to one of the links, the mechanism is referred to as a crank-slider, or slider-crank, linkage. A sample crank-slider mechanism 40 is shown diagrammatically in FIG. 16. The link 42 is the base link, the link 44 is the crank, the link 46 is the connecting rod, and link 48 is the slider, which is constrained to translational movement along the base link 42, as indicated by the double arrow 50. In the example shown in FIG. 16, the connecting rod 46 is connected to the slider 48 by a wrist pin or pivot pin 52 so that the joint both rotates and slides. The most common example of a crank-slider mechanism is the crankshaft-piston assembly in a steam engine or reciprocating automobile or internal combustion engine.

The present invention relates to a mechanism which combines a parallelogram linkage with a crank-slider mechanism, and which may stack or concatenate 4-bar parallelogram linkages in extensible structures. The related art shows various four-bar linkages, parallelogram linkages, and crank-slider mechanisms, but none which show or suggest the combination of structures in the present invention.

Four-bar linkages have been used in various exercise devices. U.S. Pat. No. 5,299,993, issued Apr. 5, 1994 to T. G. Habing, describes an articulated lower body exercise device with spring-biased pedals with parallel links which are unequal in length, the spring bias being applied by a pulley. U.S., Pat. No. 5,290,211, issued Mar. 1, 1994 to K. W. Stearns, discloses an exercise device with pedals connected to a frame by parallelogram linkages, but no crank-slider is disclosed. U.S. Pat. No. 4,828,254, issued May 9, 1989 to H. Maag, teaches an exercise device with a sliding carriage for doing leg presses in which the carriage is a crank-slider that is part of a four-bar linkage which is not a parallelogram linkage.

Four-bar linkages have also been used in conjunction with conveyor belts. U.S. Pat. No. 4,096,953, issued Jun. 27, 1978 to Kellermann et al., shows a mechanism for moving polystyrene chips on a conveyor belt that features a four-bar parallel linkage driven by a cam, no crank-slider being shown. U.S. Pat. No. 5,439,091, issued Aug. 8. 1995 to A. C. Mason, describes a reciprocating lift mechanism for lifting a workpiece on a conveyor belt up to a welder that has a parallelogram linkage with bell cranks and a Scott-Russell straight-line mechanism including a slider block attached to the frame of a welding press, but does not show a crank-slider. U.S. Pat. No. 4,928,950, issued May 29, 1990 to L. M. Sardella, shows a rotary feed mechanism for a conveyor belt used in a box-making machine which has a four-bar rocker mechanism, but does not show a crank-slider.

Various lifting devices are known which employ a parallelogram linkage. U.S. Pat. No. 5,865,593, issued Feb. 2, 1999 to A. Cohn, shows a wheelchair lift having a wheelchair platform connected to a frame by a parallelogram linkage. U.S. Pat. No. 6,318,929, issued Nov. 20, 2001 to S. T. Basta, discloses a boatlift having two parallel parallelogram linkages joined by a crossbar and raised by a hydraulic cylinder having its piston rod connected to the crossbar, no crank-slider being shown. U.S. Pat. No. 5,597,199, issued Jan. 28, 1997 to Hoffman et al., describes an ottoman with a lift mechanism for raising a table from the interior of the ottoman which uses a four-bar mechanism, but no crank-slider.

U.S. Pat. No. 6,289,867, issued Sep. 18, 2001 to P. D. Free, shows a rotary engine with a parallelogram linkage in the transmission, but no crank-slider. U.S. Pat. No. 4,387,876, issued Jun. 14, 1983 to R. H. Nathan, teaches a mechanism for generating a constant force to balance mass in a seat, scale, or other device. The basic mechanism includes two rigid links connected by a spring link, the spring being such that the horizontal component of force exerted by the spring on the second link and parallel to the first link is constant, regardless of the position on the second link where the spring link is attached. The patent also describes a variation which has a parallelogram configuration, and shows a seat with a modified parallelogram with a slider on one of the links, the slider being connected by the spring to a constant force generator. However, the slider is not absolutely free to slide, but has its position fixed by a screw to adjust the constant force being applied. The patent also shows two parallelogram linkages chained together, but without a crank-slider.

U.S. Pat. No. 4,662,076, issued May 5, 1987 to M. M. Saadat, shows a drawing compass with a pin parallel to a pencil and two parallel connecting bars pivotally attached between the two. The two bars are pivotally attached to a slider on the pin. A crank is pivotally attached to a collar on the pin and to the center of one of the two parallel bars. The slider is moved up and down on the pin by a screw mechanism, which is fixed in position by a locknut. The crank is not a slider-crank.

U.S. Pat. No. 5,048,552, issued Sep. 17, 1991 to D. A. Bourne, describes trip valve actuators used in conjunction with seismic vibration sensors and transducers. The device uses several stages of levers, some of which use four-bar linkages which are concatenated or chained together, but the linkages do not appear to be parallelogram linkages and do not include a crank-slider.

None of the above inventions and patents, taken either singly or in combination, is seen to describe the instant invention as claimed.

### SUMMARY OF THE INVENTION

The sliding, articulated, extension-retraction mechanism combines a four-bar parallelogram linkage with a crank-slider. The crank-slider may be disposed on the interior of the parallelogram, or the crank-slider may be disposed on an extension of the leveling link opposite the fixed or base link, or a second parallelogram linkage may replace the crank-slider. The parallelogram linkages may be stacked to create an extensible, retractable structure. The joints between stacked parallelograms may be formed by either a rectangular housing with the links of each parallelogram joined to opposite diagonal corners of the housing for a low height-wide base storage position, or a trapezoidal housing with the links of each parallelogram joined to adjacent corners of the housing for a high height-narrow base storage position.

The sliding, articulated, extension-retraction mechanism may be actuated by manual, mechanical, hydraulic, pneumatic, or electrical methods. Preferred actuators include an extensible cylinder (hydraulic, pneumatic, or electric) mounted in triangular stirrups with the stirrups positioned on opposite sides of a joint between parallelogram linkages so that the cylinder is parallel to the links when the stacked linkages are in an extended position, and a pulley-cable actuator which has a plurality of pulleys positioned at the corners and along the links of stacked parallelogram linkages.

The sliding, articulated, extension-retraction mechanism can be employed in extensible and retractable structures, such as scaffolds, racks, camping tents, portable masts, folding posts, lifting structures, extendible arms, robotics, walls, and various other applications.

Accordingly, it is a principal object of the invention to provide a linkage system for extensible and retractable structures having stacked parallelogram linkages coupled by crank-slider mechanisms.

It is another object of the invention to provide a stable joint housing for stacked parallelogram linkage structures coupled by crank-sliders.

It is a further object of the invention to provide a linkage system for extensible and retractable structures having stacked parallelogram linkages in order to raise and lower a platform which is continuously maintained level and parallel to a base linkage.

Still another object of the invention is to describe a parallelogram linkage coupled with a crank-slider mechanism which may be actuated by any conventional actuating means to extend or retract a structure.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a diagrammatic view of a base unit of a sliding, articulated, extension-retraction mechanism according to the present invention.

FIG. 2 is a diagrammatic view of an expanded base unit of a sliding, articulated, extension-retraction mechanism according to the present invention.

FIG. 3 is a diagrammatic view of a sliding, articulated, extension-retraction mechanism according to the present invention.

FIG. 4 is a diagrammatic view of an alternative crank-slider for a sliding, articulated, extension-retraction mechanism according to the present invention.

FIG. 5 is a diagrammatic view of another alternative crank-slider for a sliding, articulated, extension-retraction mechanism according to the present invention.

FIG. 6A is a diagrammatic view of a juxtaposition joint for a sliding, articulated, extension-retraction mechanism according to the present invention in an open position.

FIG. 6B is a diagrammatic view of a juxtaposition joint for a sliding, articulated, extension-retraction mechanism according to the present invention in a closed position.

FIG. 7A is a fragmented, perspective view of a juxtaposition joint for a sliding, articulated, extension-retraction mechanism according to the present invention.

FIG. 7B is a fragmented, perspective view of a juxtaposition joint for a sliding, articulated, extension-retraction mechanism according to the present invention with the casing broken away.

FIG. 8A is an elevation view of a mast constructed with a juxtaposition joint sliding, articulated, extension-retraction mechanism according to the present invention in a retracted position.

FIG. 8B is a perspective view of a mast constructed with a juxtaposition joint sliding, articulated, extension-retraction mechanism according to the present invention in an intermediate position.

FIG. 8C is an elevation view of a mast constructed with a juxtaposition joint sliding, articulated, extension-retraction mechanism according to the present invention in an extended position.

FIG. 9A is a diagrammatic view of a stack joint for a sliding, articulated, extension-retraction mechanism according to the present invention in an open position.

FIG. 9B is a diagrammatic view of a stack joint for a sliding, articulated, extension-retraction mechanism according to the present invention in a closed position.

FIG. 10A is an elevation view of a stack joint for a sliding, articulated, extension-retraction mechanism according to the present invention in an open position.

FIG. 10B is an elevation view of a stack joint for a sliding, articulated, extension-retraction mechanism according to the present invention in a closed position.

FIG. 11A is an elevation view of an aerial platform made with a stack joint sliding, articulated, extension-retraction mechanism according to the present invention in an extended position.

FIG. 11B is an elevation view of an aerial platform made with a stack joint sliding, articulated, extension-retraction mechanism according to the present invention in a retracted position.

FIG. 12 is a fragmented perspective view of an interlacing joint for a sliding, articulated, extension-retraction mechanism according to the present invention.

FIG. 13 shows a side elevation view of a hydraulic actuator attached to a sliding, articulated, extension-retraction mechanism according to the present invention.

FIG. 14 is a schematic view of a cable and pulley actuator attached to a sliding, articulated, extension-retraction mechanism according to the present invention.

FIG. 15 is a diagrammatic view of a prior art parallelogram linkage.

FIG. 16 is a diagrammatic view of a prior art crank-slider mechanism.

Similar reference characters denote corresponding features consistently throughout the attached drawings.

### DETAILED DESCRIPTION OF THE PREFERRED EMBODIMENTS

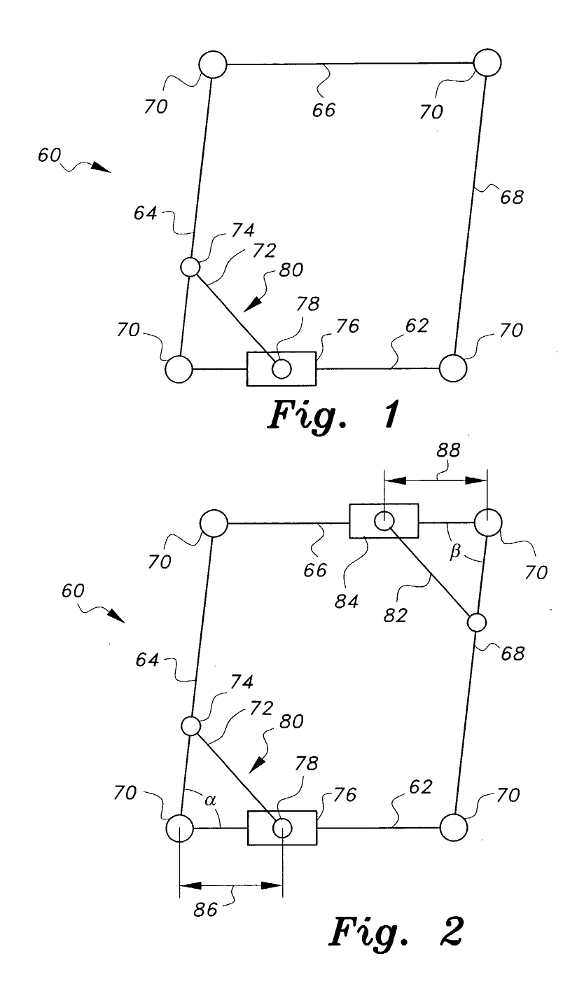

The present invention is a sliding, articulated, extension-retraction (SAER) mechanism that combines a four-bar parallelogram linkage with a crank-slider. FIG. 1 diagrammatically shows a base unit 60 of the SAER mechanism, which has a parallelogram linkage formed by bars or links 62, 64, 66, and 68 which are joined at their ends by pivot pins 70. A connecting rod 72 has one end pivotally connected to crank 64 at a fixed position on the crank 64 by pivot pin 74, and a second end pivotally connected to slider block 76 by pivot pin 78, thereby combining a parallelogram linkage with a crank-slider 80 disposed on the interior of the parallelogram and extending between adjacent sides of the parallelogram. FIG. 2 diagrammatically shows an expansion of the base unit formed by adding a second crank-slider 82 to the diagonally opposite corner of the parallelogram opposite crank-slider 80. It will be apparent from inspection that as the crank 64 is rotated through angle α, slider 76 is displaced a distance 86 on link 62, while crank 68 will simultaneously be rotated through an angle β congruent to angle α, and slider 84 will be displaced a distance 88 on link 66 congruent to the distance 86.

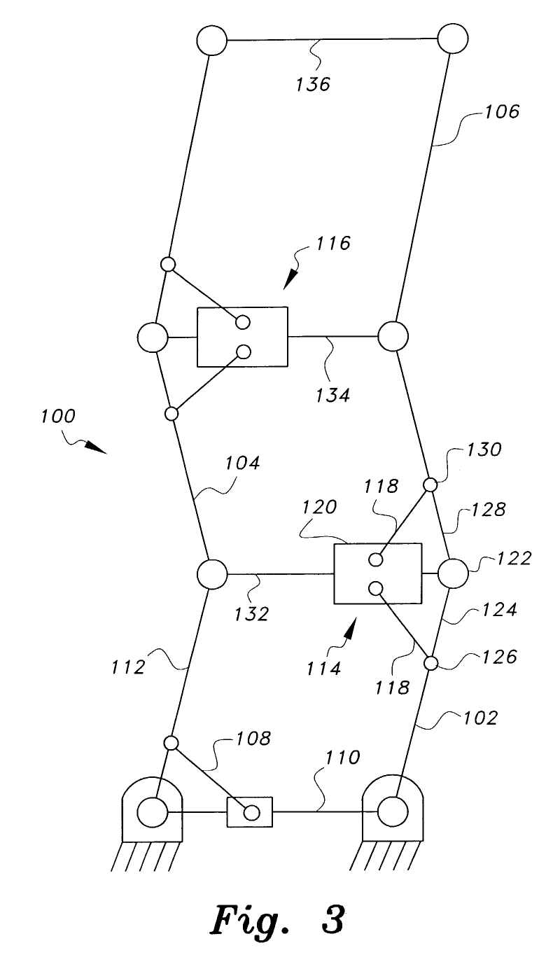

According to the present invention, the base units 60 can be stacked as shown diagrammatically in FIG. 3 to form the sliding, articulated, extension-retraction mechanism 100. The SAER mechanism 100 shown in FIG. 3 has three parallelogram linkages 102, 104, and 106 stacked vertically with a first crank-slider 108 attached between base link 110 and crank 112, and with first tandem crank-slider 114 between parallelogram linkages 102 and 104, and second tandem crank-slider 116 between parallelogram linkages 104 and 106. Each tandem crank-slider 114 and 116 has a similar structure, and will therefore be explained with reference to tandem crank-slider 114 only. Tandem crank-slider 114 has a pair of connecting rods 118 of equal length, each connecting rod 118 having a first end pivotally connected to the same slider block 120 at an equal distance from the common pivot pin 122. Each connecting rod 118 has a second end, one of the second ends being pivotally attached to crank 124 of parallelogram linkage 102 at pin 126, the other second end being pivotally attached to crank 128 of parallelogram linkage 104 at pivot pin 130, pins 126 and 130 being displaced from common pivot pin 122 by an equal distance. Hence, tandem crank-slider 114 defines two congruent triangles with a common side on level link 132, regardless of the position of slider block 120 on level link 132.

The effect of this arrangement is that the SAER mechanism 100 has one degree of freedom, i.e., movement of any one of the links in the structure constrains movement of the other links, so that the entire structure extends or retracts. For example, clockwise rotation of crank 112 by moving the slider block of crank slider 108 to the right with consequent clockwise rotation of parallel crank 126 through the same angle results in retraction of parallelogram linkage 102 and consequent lowering of leveling bar 132, and simultaneously results in retraction of parallelograms 104 and 106 with simultaneous and parallel lowering of links 134 and 136 due to counterclockwise rotation of crank 128 through an angle in equal in magnitude but opposite in direction. Hence, extension and retraction of parallelograms 102, 104 and 106 is synchronized.

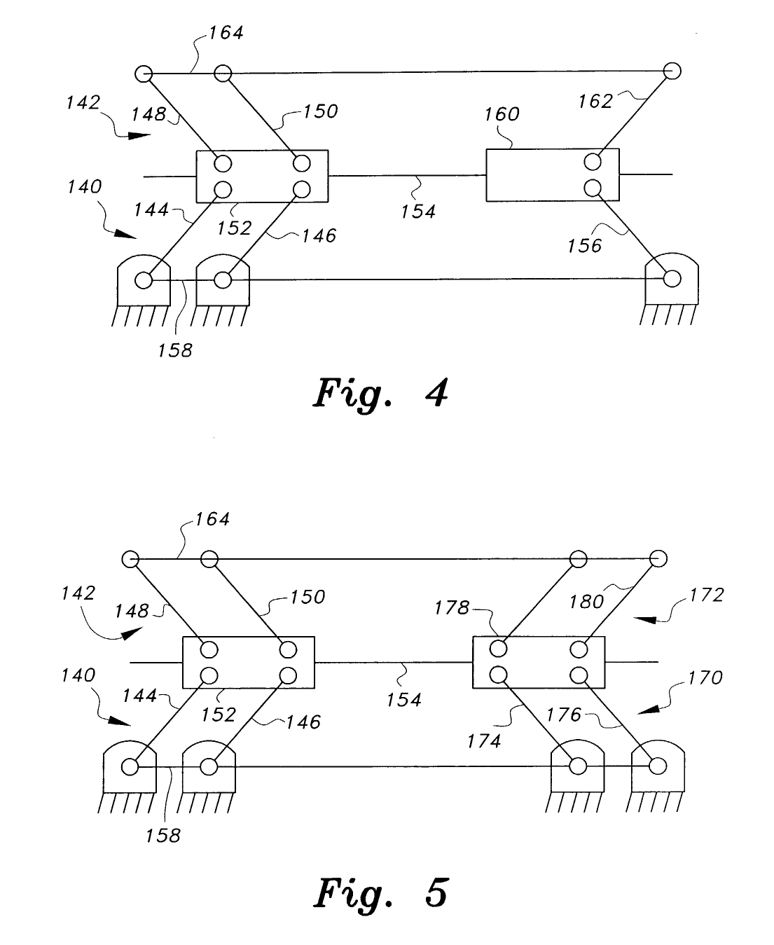

FIG. 1 shows a base unit 60 in which the crank-slider 80 is disposed across an interior angle of the parallelogram linkage. FIG. 4 shows an alternative arrangement in which parallel linkages 140 and 142 are stacked with cranks 144, 146, 148, and 150 separately pinned to pivot pins on opposite ends of a common slider block 152 which is constrained to slide along a common intermediate bar 154. The crank-slider mechanism in this arrangement is formed by a crank 156 having a first end pivotally attached to the end of an extension of the base link 158 and a second end pivotally pinned to a tandem slider block 160 which is constrained to slide along an extension of intermediate bar 154. A symmetric upper crank-slider is formed by an upper crank 162 having one end pivotally pinned to tandem slider block 160 and a second end pinned to an extension of upper level link 164.

As crank 156 is rotated counterclockwise, intermediate bar 154 is lowered, retracting parallelogram linkage 140, while tandem block 160 constrains upper crank 162 to rotate clockwise by an equal angular measure, thereby retracting upper level link 154 by an equal amount.

FIG. 5 illustrates a modification of the mechanism of FIG. 4, in which single cranks 156 and 162 are replaced by parallelogram linkages 170 and 172 which have one end of each of their cranks 174, 176 and 178, 180, respectively, separately pinned to tandem slider block 160. Operation of the mechanism is similar to FIG. 4, and will not be described further. It has been found that the stacked parallelogram crank-slider linkages 170 and 172 of FIG. 5 exhibits somewhat more stable behavior than the single crank sliders 156 and 162 of the mechanism shown in FIG. 4.

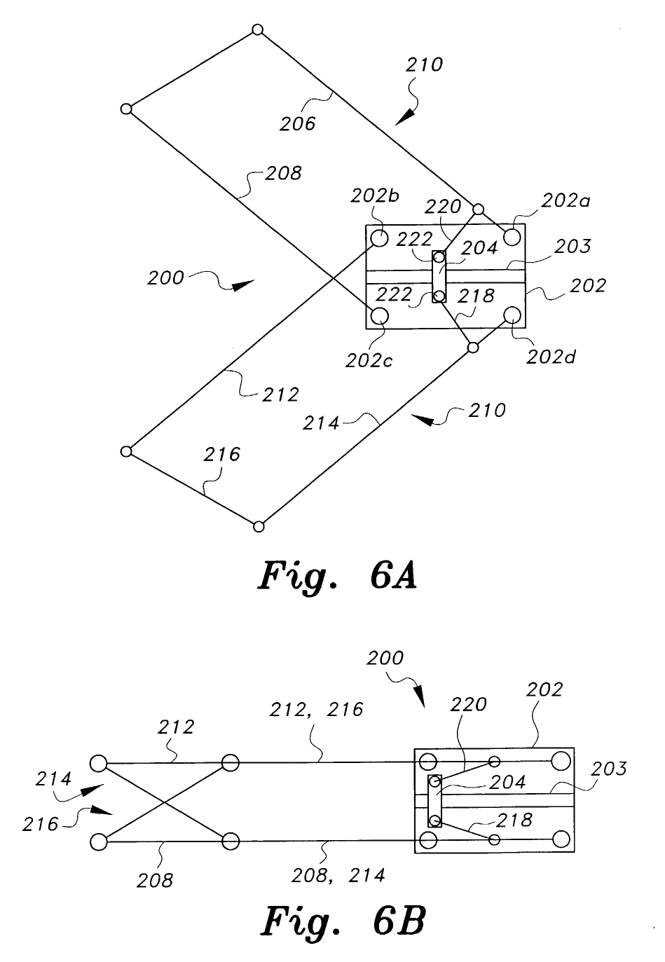

In a practical SAER mechanism, there are at least two ways that the four bar structures can retract, depending upon the structure of the joints. FIGS. 6A and 6B show a juxtaposition base 200 in diagrammatic form. The juxtaposition base has a rectangular housing 202 with a common slider 204 slidable along a guide 203 defined by the housing 202. The guide 203 may be a rail, slot, track, or other suitable structure. Two bars 206 and 208 of the upper four-bar structure 210 are pivotally connected to diagonally opposite corners 202a, 202c of the rectangular housing 202, and two bars 212 and 214 of the lower four-bar structure 216 are pivotally connected to the other pair of diagonally opposite corners 202b, 202d of the rectangular housing 202. The crank-sliders 218 and 220 are pivotally connected to the common slider 204 by pivot pins 222.

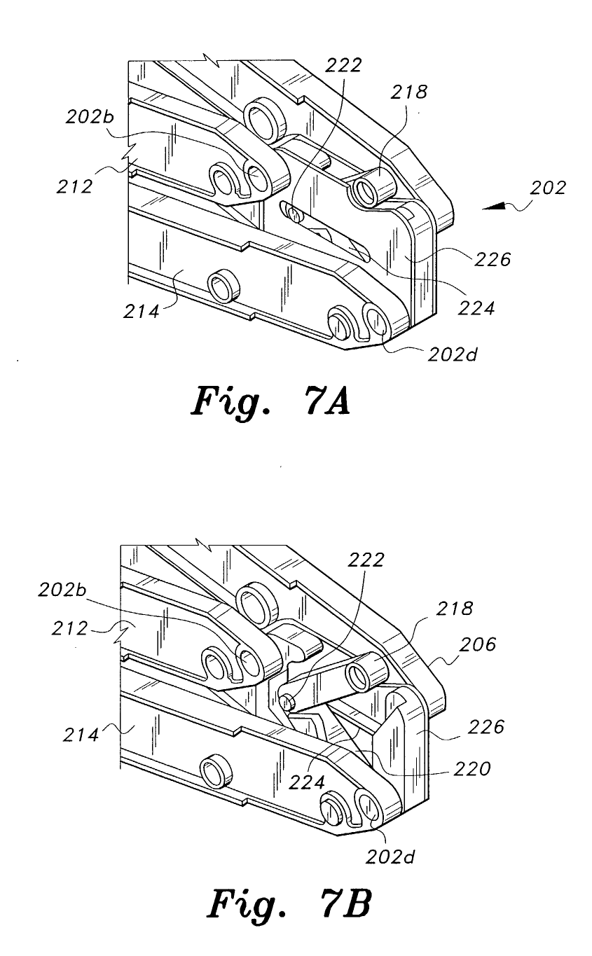

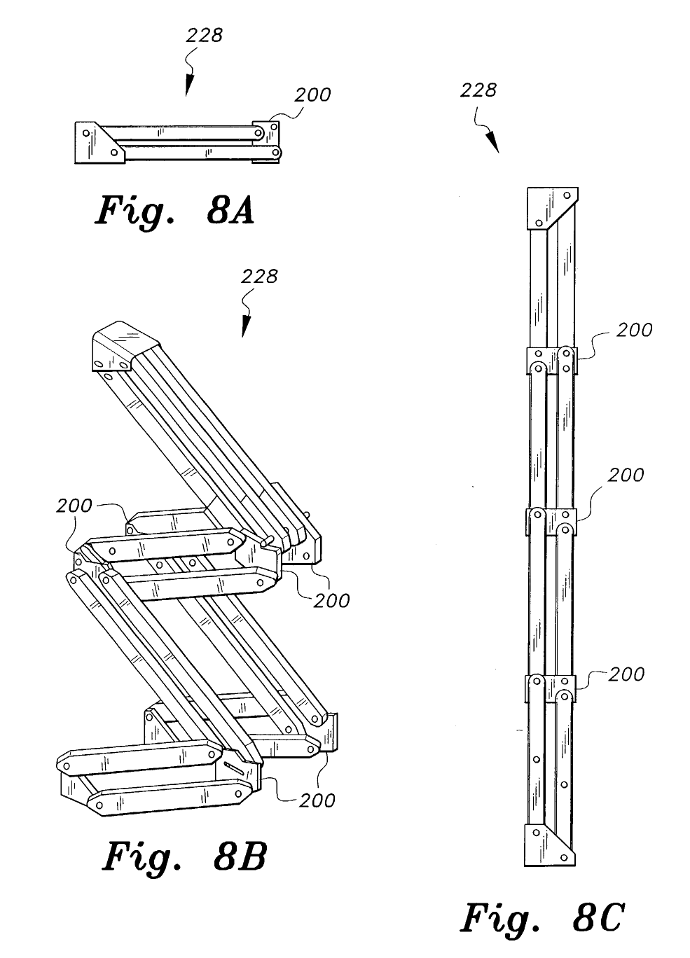

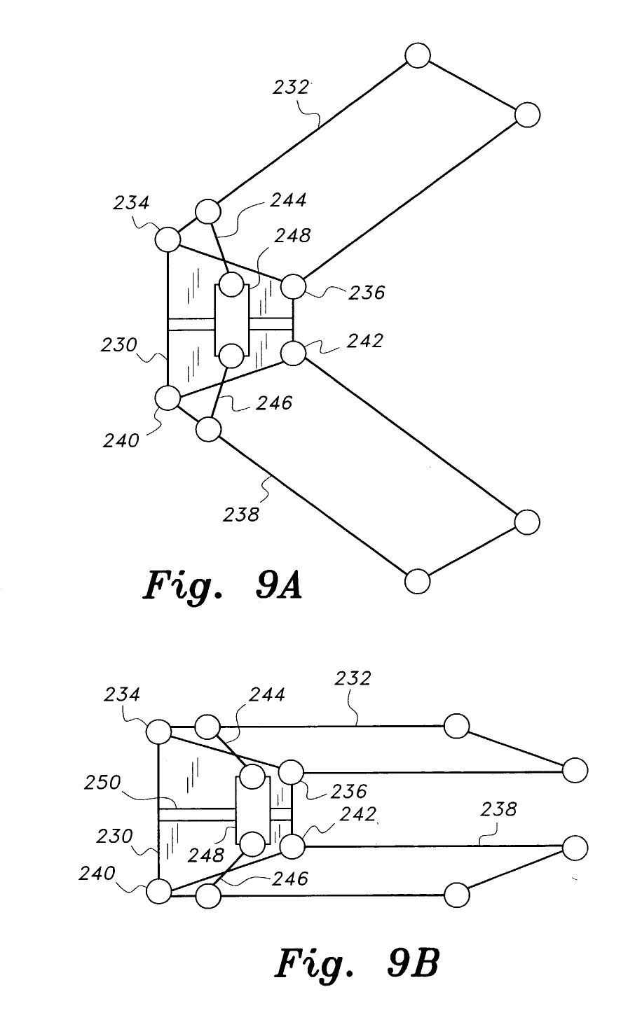

FIGS. 7A and 7B show pictorial drawings in which the rectangular housing 202 has a single slot 224, the crank-sliders 218 and 220 being connected to a single pivot pin 222 slidable in the slot 224. The pivot pin 222 may have a roller bearing (not shown) or other suitable bearing slidable in the slot 224 to reduce friction, and the crank-sliders 218 and 220 and pivot pin 222 are at least partially chambered in a casing 226 for lateral support. FIGS. 8A, 8B, and 8C show a mast 228 having juxtaposition base joints 200 in the collapsed, intermediate, and extended positions, respectively. As seen in FIGS. 8A and 8C, the advantage of the juxtaposition base 200 is that it provides for a large ratio of extended height to retracted height, since juxtaposition base joints 200 can be aligned to collapse in parallel alignment when retracted. The collapsed position will, however, have a relatively wide storage configuration. It will be noted that the mast 228 has two parallel stacks of SAER mechanisms, which may be connected by cross links or torsion bars for synchronized extension and contraction of the two stacks.

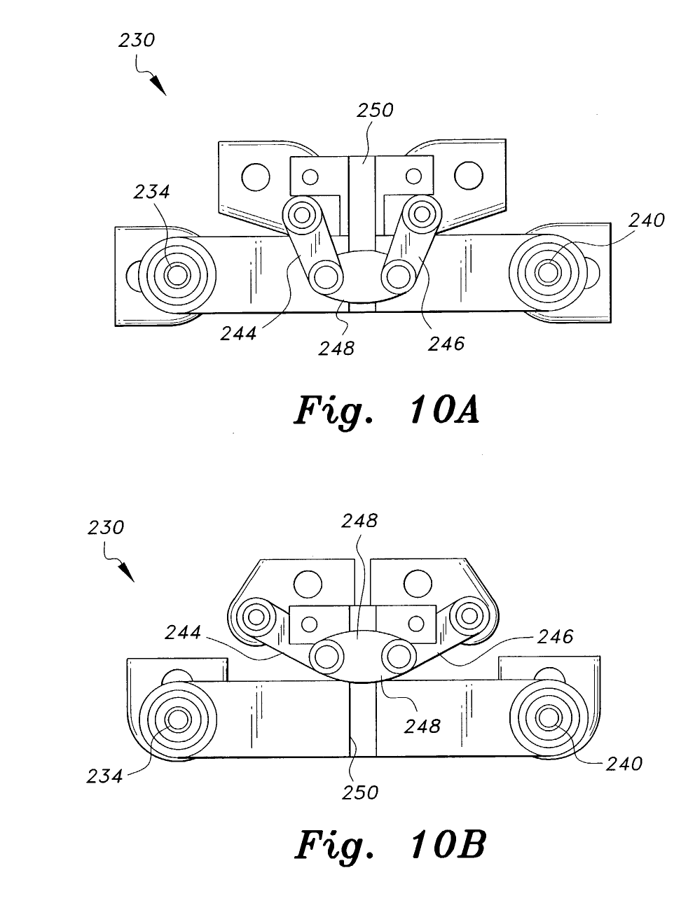

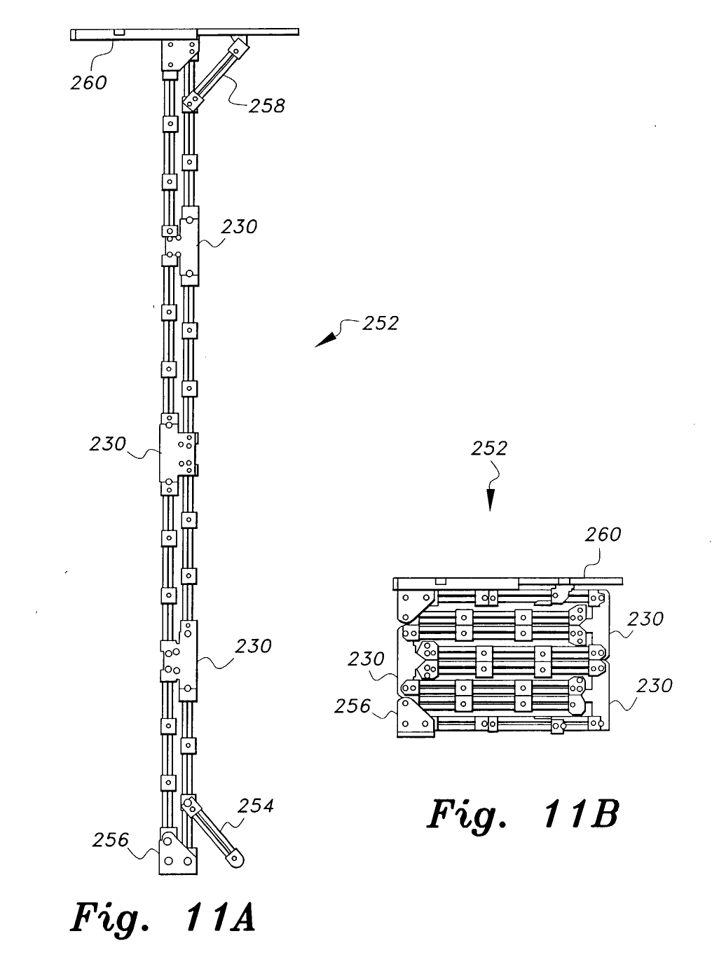

A second way that the four-bar structures can retract makes use of a stack base joint housing 230, shown diagrammatically in FIGS. 9A and 9B and pictorially in FIGS. 10A and 10B. The stack base housing 230 is generally trapezoidal in shape. As shown in FIGS. 9A and 9B, two bars of the upper parallelogram linkage 232 are pivotally attached to adjacent upper corners of the trapezoid by pivot pins 234 and 236, while two bars of the lower parallelogram linkage 238 are pivotally attached to adjacent lower corners of the trapezoid by pivot pins 240 and 242. The crank-sliders 244 and 246 are pivotally attached to common slider bar 248, which is constrained to slide on rib 250 defined by the stack base housing 230. The stack base joint 230 has a lower ratio of extended height to retracted height than the juxtaposition base 200, but is narrower when retracted to the storage position and provides more space for installation of actuators on the structure. FIGS. 11A and 11B show an aerial platform 252 constructed with the stack base joint 230 in the extended and retracted positions. As shown in FIG. 11A, the mast may have a center link 254 pivotally fixed to the ground which acts as a crank-slider to move the sliding base 256 to extend and retract the mechanism. A parallel center link 258 may be attached to the platform 260 for the same purpose. The stack base joint 230 may be used in conjunction with the juxtaposition base in the same structure to take advantage of the advantageous features of both joints.

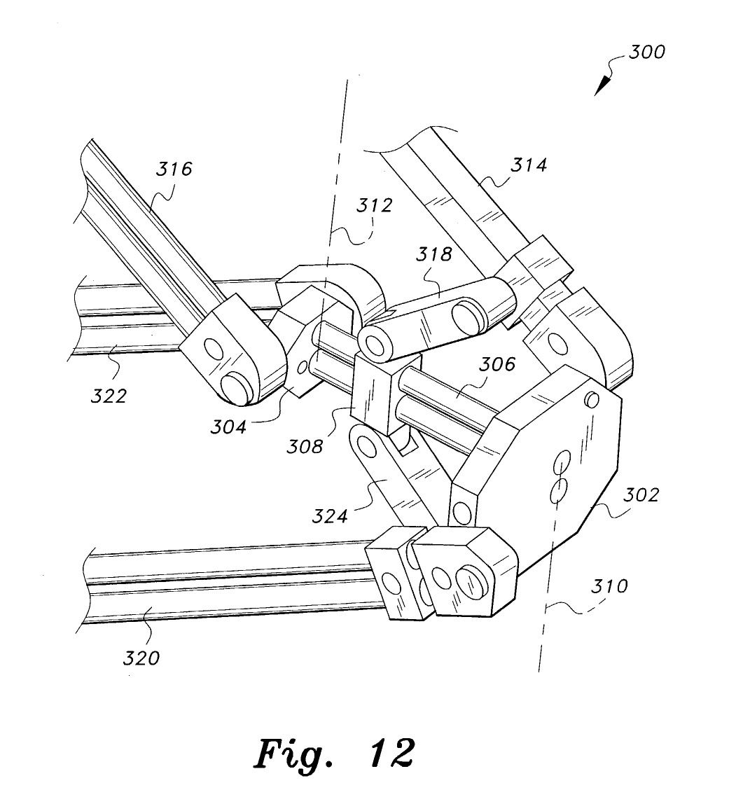

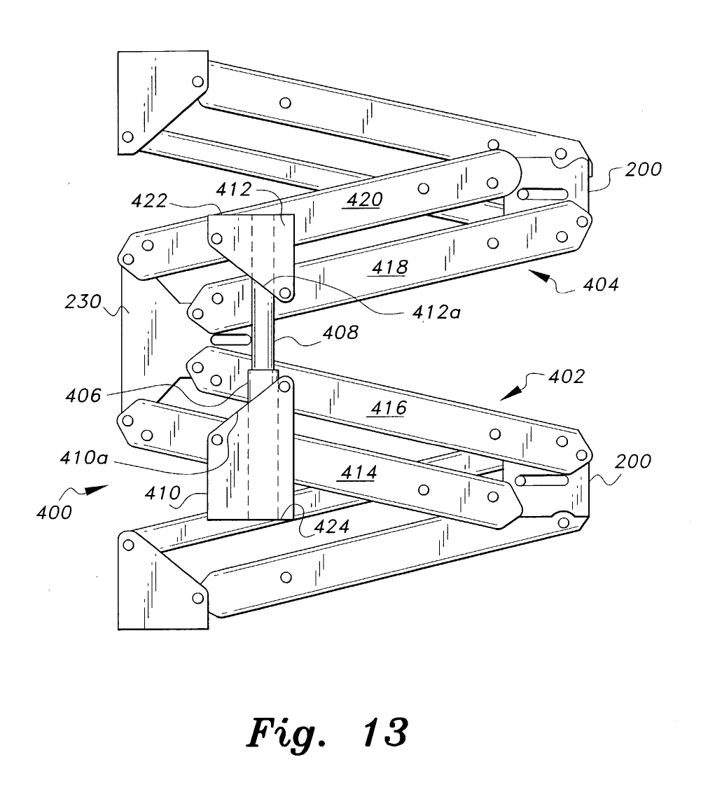

A third joint which may be used in a sliding, articulated, extension-retraction mechanism according to the present invention is an interlacing joint, which combines features of both the juxtaposition joint 200 and the stack joint 230. In a two-dimensional diagrammatic view, the interlacing joint appears identical to the stack joint 230, as seen in FIGS. 9A and 9B. However, while the cranks in the upper and lower parallelograms are coplanar in the stack joint 230, and while the cranks of the upper parallelogram 210 are connected to diagonally opposite corners of one side of the housing 202 and the cranks of the lower parallelogram 216 are connected to diagonally opposite corners of the other side of the juxtaposition joint 200, in the interlacing joint the cranks of the upper parallelogram are connected to adjacent corners of the trapezoid, but on opposite sides. This is best illustrated by the perspective view of the interlacing joint shown in FIG. 12.

The interlacing joint 300 includes a pair of parallel end plates 302 and 304. The parallel plates 302 and 304 are connected at the ends of at least a pair of parallel slide support rods 306, the slider body 308 being mounted on the slide support rods 306. The parallel support rods 306 form the common bar of adjacent parallelogram base units. The parallel support rods 306 define a plane medially through the interlacing joint 300 which bisects the plates 302 and 304 along the dashed lines 310 and 312, respectively. One of the upper parallelogram cranks 314 is pivotally connected to one side of the first plate 302, while the other upper parallelogram crank 316 is pivotally connected to the second plate 304 on the opposite side of the medial plane. The upper parallelogram crank-slider 318 is pivotally connected to both the crank 314 and the slider body 308. Similarly, one of the lower parallelogram cranks 320 is pivotally connected to the first plate 302 on the opposite side of the medial plane from upper parallelogram crank 314, while the other lower parallelogram crank 322 is pivotally connected to second plate 304 on the opposite side of the medial plane from crank 320. The lower parallelogram crank-slider 324 is pivotally connected to both the crank 320 and slider body 308.

It will be apparent that with the interlacing joint, the upper and lower parallelogram linkages are not coplanar, but there is a dihedral angle of twist defined between the upper and lower parallelogram linkages. Nevertheless, the interlacing joint 300 uses less material and has been found to behave more rigidly than either the juxtaposition joint 200 or the stack joint 230.

As mentioned previously, the SAER mechanism is a one-degree of freedom system. The minimum number of actuators required to extend or retract a SAER structure is one. The actuator can be manual, mechanical, hydraulic, or electric, and may operate by translational or rotational movement.

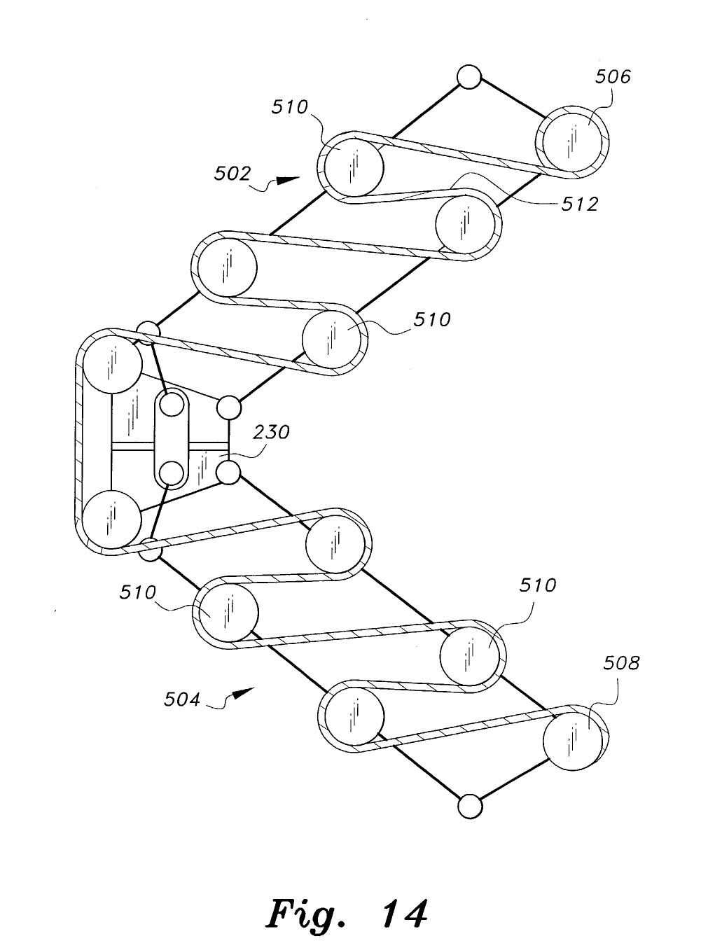

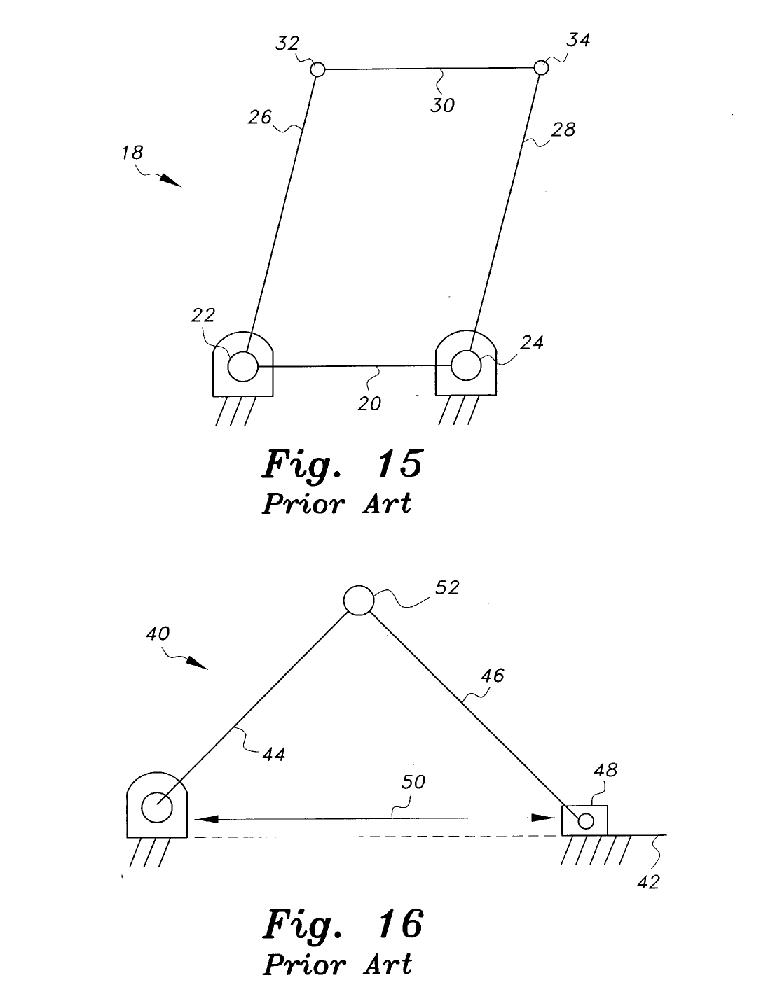

FIG. 13 shows a hydraulic actuator 400 installed between adjacent four-bar parallelogram linkages. In FIG. 13 the hydraulic actuator 400 is disposed between stacked parallelogram linkages 402 and 404. Parallelogram linkages 402 and 404 are joined to each other by a stack base joint 230 in the fashion described above. Linkage 402 is joined to the next lower linkage by a juxtaposition joint 200, and linkage 404 is also joined to the next higher linkage by a juxtaposition joint 200. The hydraulic actuator 400 is in the form of a conventional hydraulic cylinder (the hydraulic supply lines, pump, accumulator, and control device are omitted from FIG. 13 for clarity, these components being standard components of a hydraulic system well known to one skilled in the mechanical arts), the actuator 400 having a conventional cylinder 406 and a piston rod 408 which extends from and retracts into the cylinder 406 in conventional fashion. In a SAER mechanism according to the present invention, the hydraulic actuator 400 is mounted between two stirrups 410 and 412, one stirrup 410 being pivotally mounted to two bars 414 and 416 of the lower parallelogram linkage 402, the other stirrup being pivotally mounted to two bars 418 and 420 of the upper parallelogram linkage 404. Each stirrup 410 and 412 preferably has a pair of parallel, generally triangular side plates, although the side plates may be trapezoidal, as shown by stirrup 410. However, according to the present invention the open end of the stirrups 410 and 412 are sloped to permit pivotal attachment of the ends of the sloped sides 410a and 412a, respectively, to the cranks of the parallel linkages 402 and 404, respectively, and a closed end against which the base of the cylinder 406 and the piston rod 408 bear, respectively, and to which they are attached. Since the stack joint 230 has a common slider 248 (shown in FIGS. 9B, 10A, 10B), the lower pair of bars 414 and 416 and the upper pair of bars 418 and 420 rotate through equal angles but opposite directions as the hydraulic actuator 400 extends and retracts, so that the bottom plate 422 and 424 of the upper 412 and lower 410 stirrups, respectively, remain parallel with each other and level with the ground or other supporting surface.

Another actuator which may be used with the SAER of the present invention is a cable and pulley arrangement, shown diagrammatically in FIG. 14. FIG. 14 shows two four-bar parallelogram linkages, including upper parallelogram linkage 502 and lower parallelogram linkage 504 which are connected by a stack base joint 230. An upper winch 506 or take-up drum is shown mounted to the upper right hand corner of upper linkage 502, and a lower winch 508 or take-up drum is shown mounted in the lower right corner of lower linkage 504. A plurality of pulleys 510 is mounted in staggered formation on opposite links of the upper 502 and lower 504 parallelogram linkages. A cable 512 has a first end attached to upper winch 506, a second end attached to lower winch 508, and an intermediate length which crosses back and forth between parallel bars and around pulleys 510, partitioning each parallel linkage 502 and 504 into a plurality of smaller parallelogram units. The cable 512 passes over two adjacent pulleys 510 on one side of the stack base joint 230, avoiding entanglements which might otherwise result. As cable 512 is wound around lower winch 508, the length of the cable 512 progressively shortens, thereby shortening the diagonal length between the pulleys 510 and retracting the linkages 502 and 504. Upper winch 506 may be spring-biased, so that as cable 512 is played out from lower drum 508, it is rewound on upper winch 506, causing the linkages 502 and 504 to extend. A hand crank, electric motors, or other means may operate the upper and lower winches 506 and 508.

It will be obvious to those skilled in the art that the sliding, articulated, extension-retraction mechanism of the present invention has particular utility in the fabrication of various extensible-retractable mechanisms, including scaffolds, racks, camping tents, portable masts, folding posts, lifting structures, extendible arms, robotics, walls, and various other applications.

It is to be understood that the present invention is not limited to the sole embodiments described above, but encompasses any and all embodiments within the scope of the following claims.

I claim:

1. A sliding, articulated, extension-retraction mechanism, comprising:
(a) a plurality of stacked parallelogram four-bar base units, each base unit having four rigid bars pivotally connected in order to define a parallelogram, adjacent base units in the plurality of stacked base units having one common bar and parallel first and second crank bars pivotally attached at opposite ends of said common bar;
(b) a tandem slider disposed on said common bar; and
(c) first and second crank-sliders attached to adjacent base units in said plurality of stacked base units, respectively, each crank-slider including a connecting rod having a first end pivotally attached to said tandem slider and a second end pivotally connected to the first crank bar of said adjacent base units;
whereby when one of the first and second cranks of one of the plurality of stacked base units is rotated through a first angle, the corresponding first and second cranks of the adjacent base unit are rotated through a second angle equal in magnitude but opposite in direction, thereby extending and retracting adjacent base units in parallel.

2. The sliding, articulated, extension-retraction mechanism according to claim 1, wherein at least one of the adjacent base units further comprises a third crank-slider disposed in a corner of said one of the base units diagonally opposite to said first and second crank-sliders, the third crank-slider including a connecting rod pivotally attached to the second crank and a slider disposed on the bar parallel to said common bar.

3. The sliding, articulated, extension-retraction mechanism according to claim 1, further comprising actuator means for extending and retracting the adjacent base units.

4. The sliding, articulated, extension-retraction mechanism according to claim 3, wherein said actuator means is selected from the group consisting of a manual actuator, a mechanical actuator, a hydraulic actuator, a pneumatic actuator, and an electrical actuator.

5. The sliding, articulated, extension-retraction mechanism according to claim 1, further including:
first and second stirrups, each of the stirrups having a bottom plate, parallel opposing side plates extending from the bottom plate, and an open end opposite said bottom plate, the open end being sloped relative to said bottom plate and defining opposing corners; and
a hydraulic cylinder having a cylinder and a rod extendible from the cylinder;
wherein the first and second cranks of a first base unit of said plurality of base units are pivotally attached to the opposing corners, respectively, of the open end of said first stirrup;
wherein the first and second cranks of a second base unit of said plurality of base units are pivotally attached to the opposing corners, respectively, of the open end of said second stirrup, the second base unit being adjacent the first base unit, the open ends of said first and second stirrups facing each other; and
wherein the cylinder is attached to the bottom plate of said first stirrup and the rod is attached to the bottom plate of said second stirrup;
wherein the first and second base units are extended and retracted by extension and retraction of the rod.

6. The sliding, articulated, extension-retraction mechanism according to claim 1, further including:
a winch attached to a first base unit of said plurality of base units;
a take-up drum attached to a second base unit of said plurality of base units, the second base unit being adjacent to the first base unit;
a plurality of pulleys attached to the first and second cranks of the first and second base units, the pulleys being disposed between the winch and the take-up drum; and
a cable having a first end and a second end, the first end being attached to the winch and the second end being attached to the take-up drum;
wherein the first and second base units are extended and retracted by extending and retracting cable from and to the winch.

7. The sliding, articulated, extension-retraction mechanism according to claim 1, wherein:
the first end of each said connecting rod is attached to said tandem slider at an equal distance from a common pivot point located between the first crank of each said adjacent base unit;
the second end of each said connecting rod is pivotally attached to the first crank of said adjacent parallelogram base units at an equal distance from the common pivot point;
whereby said tandem slider defines two congruent triangles with a common side so that the sliding, articulated, extension-retraction mechanism has one degree of freedom, each first crank of the adjacent base units rotating through an equal angular measure when said tandem slider moves.

8. The sliding, articulated, extension-retraction mechanism according to claim 1, further comprising a juxtaposition joint, said juxtaposition joint having:
a rectangular housing;
a guide defined by said housing; and
a common slider slidable along said guide;
wherein two bars of a first base unit of said plurality of base units are pivotally connected to diagonally opposite corners of said rectangular housing and two bars of a second base unit of said plurality of base units are pivotally connected to the other pair of diagonally opposite corners of said rectangular housing, the second base unit being adjacent the first base unit.

9. The sliding, articulated, extension-retraction mechanism according to claim 8, wherein:
the guide consists of a single slot defined in said rectangular housing; and
the common slider comprises a single pivot pin slidable in the single slot, the first and second crank sliders being pivotally connected to said pivot pin.

10. The sliding, articulated, extension-retraction mechanism according to claim 9, wherein said single pivot pin further comprises a bearing slidable in the slot for reducing friction, the rectangular housing further comprising a casing, said crank-sliders and said single pivot pin being at least partially chambered in said casing for lateral support.

11. The sliding, articulated, extension-retraction mechanism according to claim 1, further comprising a stack joint having:
a trapezoidal housing;
a guide defined by said trapezoidal housing; and
a common slider slidably disposed along said guide;
wherein two bars of a first base unit of said plurality of base units are pivotally attached to adjacent upper corners of said trapezoid housing, and two bars of a second base unit of said plurality of base units are pivotally attached to adjacent lower corners of said trapezoid housing.

12. The sliding, articulated, extension-retraction mechanism according to claim 11, wherein:
the guide comprises a rib defined on said trapezoidal housing; and
said first and second crank-sliders are pivotally attached to opposite ends of said common slider.

13. The sliding, articulated, extension-retraction mechanism according to claim 1, further comprising an interlacing joint having:
a body defining first, second, third and fourth parallel pivot axes, wherein the pivot axes are bisected by a common plane, the intersection of the common plane with the four axes defining four points forming vertices of a trapezoid in clockwise order from first through fourth, the first, second, third, and fourth axes each having an inner end and an outer end on opposite sides of the common plane; and
wherein said tandem slider is disposed on said body;
wherein the first and second crank bars of a first base unit of said plurality of base units are attached to the outer end of the first pivot axis and the inner end of the second pivot axis, respectively;
wherein the first and second crank bars of a second base unit of said plurality of base units are attached to the outer end of the third pivot axis and the inner end of the fourth pivot axis, respectively; and
wherein the crank-sliders of the first and second base units are pivotally attached to opposite ends of said tandem slider.

14. The sliding, articulated, extension-retraction mechanism according to claim 13, wherein said body comprises:
a pair of parallel end plates;
a pair of parallel support rods, the end plates being attached to opposite ends of the support rods, the parallel support rods being disposed in a plane bisecting the parallel end plates;
wherein said tandem slider is disposed on the support rods; and
wherein the support rails form said common bar.
